(19) United States
(12) Patent Application Publication
(10) Pub. No.: US 2026/0015176 A1
(43) Pub. Date: Jan. 15, 2026

(54) A REMOTELY OPERATED PICKING VEHICLE, AN AUTOMATED STORAGE AND RETRIEVAL SYSTEM, AND A METHOD OF USING SAME

(71) Applicant: AutoStore Technology AS, Nedre Vats (NO)

(72) Inventor: Jørgen Djuve Heggebø, Langhus (NO)

(21) Appl. No.: 19/140,896

(22) PCT Filed: Nov. 27, 2023
(86) PCT No.: PCT/EP2023/083220

§ 371 Date: Jun. 18, 2025

(30) Foreign Application Priority Data
Dec. 21, 2022 (NO) 20221378

(51) Int. Cl. B65G 1/137; B65G 1/04

(52) U.S. Cl. CPC B65G 1/1375; B65G 1/0464

(57) ABSTRACT

It is disclosed a remotely operated picking vehicle (600), an automated storage and retrieval system (1) comprising the remotely operated vehicle (600), and a method of using same. The automated storage and retrieval system (1) comprises: -a rail system (108) comprising a first set of parallel rails (110) arranged in a horizontal plane (PH) and extending in a first direction (X), and a second set of parallel rails (111) arranged in the horizontal plane (PH) and extending in a second direction (Y) which is orthogonal to the first direction (X), wherein the first and second sets of rails (110,111) form a grid pattern in the horizontal plane (PH) comprising a plurality of adjacent access openings (112) defined by a pair of neighbouring rails of the first set of rails (110) and a pair of neighbouring rails of the second set of rails (111), The remotely operated picking vehicle (600) comprises:-a vehicle body (601) comprising drive means for transportation on the rail system (108); -a picker support (610) for a robotic picking device (630) or a human picker, the picker support (610) being arranged on the vehicle body (601); - a storage container handling device (620), arranged on the vehicle body (601), wherein the storage container handling device (620) is configured to receive a storage container (106) from a container handling vehicle (301) operating on the rail system (108); wherein the storage container handling device (620) is configured to support the storage container (106) when the storage container (106) is positioned such that it is at least partly lowered into one of the access openings (112) in the rail system (108) to allow the storage container (106) to be exchanged between the container handling vehicle (301) and the storage container handling device (620).

### FIELD OF THE INVENTION

The present invention relates to a remotely operated picking vehicle, in particular to a remotely operated picking vehicle for exchanging storage containers with a container handling vehicle in an automated storage and retrieval system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a, 301a, 401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c, 301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X-and Y-direction, while each storage cell may be identified by a container number in the X-, Y-and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

FIG. 5 shows examples of product items 80 stored in a storage container 106 having a height H_{f}, a width W_{f} and a length L_{f}. The storage container 106 has a horizontal cross section A_{f}.

WO2022/112055A1 discloses a remotely operated picking vehicle for an automated storage and retrieval system retrieving and storing products within storage containers.

It is an aim of the present invention to provide a remotely operated picking vehicle with improved exchangeability of storage containers with container handling vehicles in the automated storage and retrieval system.

### SUMMARY OF THE INVENTION

The present invention is set forth and characterized in the independent claims, while the dependent claims describe other characteristics of the invention.

The present disclosure relates to a remotely operated picking vehicle for an automated storage and retrieval system for retrieving and storing products within storage containers, wherein the automated storage and retrieval system comprises:
a rail system comprising a first set of parallel rails arranged in a horizontal plane and extending in a first direction, and a second set of parallel rails arranged in the horizontal plane and extending in a second direction which is orthogonal to the first direction,
wherein the first and second sets of rails form a grid pattern in the horizontal plane comprising a plurality of adjacent access openings defined by a pair of neighbouring rails of the first set of rails and a pair of neighbouring rails of the second set of rails,
wherein the remotely operated picking vehicle comprises:
   a vehicle body comprising drive means for transportation on the rail system;
   a picker support for a robotic picking device or a human picker, the picker support being arranged on the vehicle body;
   a storage container handling device, arranged on the vehicle body,
   wherein the storage container handling device is configured to receive a storage container from a container handling vehicle operating on the rail system;
   wherein the storage container handling device is configured to support the storage container when the storage container is positioned such that it is at least partly lowered into one of the access openings in the rail system to allow the storage container to be exchanged between the container handling vehicle and the storage container handling device.

The exchange of storage containers encompass that the container handling vehicle delivers a storage container to the remotely operated picking vehicle, or that the container handling vehicle retrieves a storage container from the remotely operated picking vehicle.

An effect of the remotely operated picking vehicle having a container handling device that can be moved to a position where it can support a storage container at least partly lowered into an access opening, is that the available ceiling height in the warehouse can be better utilized. The maximum distance between the container handling vehicle's gripping device and the rail system does not need to be much more than the height of the storage container. The height of the container handling vehicle can then be kept at a minimum while being able to exchange storage containers with the remotely operated picking vehicle. This also allows the remotely operated picking vehicle to operate in automated storage and retrieval systems comprising container handling vehicles as disclosed in the above-mentioned prior art.

The storage container handling device may be configured to raise the supported storage container to a position above the rail system for the remotely operated picking vehicle to be able to move along the rail system.

The storage container handling device should be able to lower the supported storage container sufficiently to let the grippers of the gripping device go clear the top of the storage container, such that the container handling vehicle can freely move away from the supported storage container.

The storage container handling device may be configured to raise the supported storage container to a position above the rail system such that content of the storage container is more accessible for a robotic/human picker located on the picker support.

The remotely operated picking vehicle may be configured to be in signal communication with a control system.

The remotely operated picking vehicle may comprise a robotic picking device. The robotic picking device may be arranged on the picker support.

The remotely operated picking vehicle may comprise a fence. The fence may encircle the picker support. The fence may improve operational safety, particularly when a human picker is present on the picker support. The fence may also serve as a mounting base for or otherwise form part of the storage container handling device.

The drive means may comprise: a first set of wheels, arranged on opposite sides of the vehicle body, for moving the remotely operated picking vehicle along a first horizontal direction on the rail system; and a second set of wheels, arranged on other opposite sides of the vehicle body, for moving the remotely operated picking vehicle along a second horizontal direction on the rail system, the second direction being perpendicular to the first direction.

Alternatively, the displacement means may comprise a set of continuous tracks, arranged on opposite sides of the body, for moving the remotely operated picking vehicle on the rail system.

The storage container handling device may comprise a storage container support.

The storage container handling device comprises an elevator device configured to raise and lower the storage container support relative to the vehicle body.

The elevator device may be a cylindrical actuator, i.e. a device which convert air and fluid pressure or electrical power into linear or rotary motion. Some examples are air or oil powered piston arrangements and electrically driven lead screws or worm gears or a chain drive.

Each storage container may comprise a flange, and the storage container support may comprise a pair of horizontally arranged arms configured to support the flange such that the storage container can be hung off on the storage container support.

Alternatively, the storage container support may be a hook or a profiled member configured to support a storage container by engagement with one side of the storage container. E.g. by having mating profiles on the storage container and the storage container support.

The flange may be arranged on a rim of the storage container. Preferably, the flange extends outwardly of the container and around the container opening.

The arms may be configured for sideways receipt of the storage container.

This configuration of the storage container handling device can lower a storage container at least partly into an access opening in the rail system without having to lower any of its own components into the access opening.

This configuration of the storage container handling device is preferably configured to support the storage container towards an upper end of the storage container.

The storage container support may be a horizontal plate configured to receive a storage container thereon. The storage container would then not need a flange to be supported.

The storage container support may be lowered into one of the access openings in the rail system or through one of the access openings and into a storage column located directly below. As such, a storage container can be positioned at least partly lowered into one of the access openings, i.e. wherein a lowermost part of the storage container is at a lower vertical elevation than an uppermost part of the rail system.

The storage container support in the form of a horizontal plate may have a thickness of 1-10 cm.

The storage container support(s) may be configured to be folded away when not in use. This may allow more space to be freed on the rail system if needed.

The storage container support may be movable between an upper position and a lower position, wherein a storage container supported by the storage container support is above the rail system when the storage container support is in the upper position, and the storage container supported by the storage container support is at least partly entered into one of the access openings in the rail system when the storage container support is in the lower position.

The upper position may be referred to as a picking position. The lower position may be referred to as an exchange position.

In the picking position, the storage container handling device may be configured to support the storage container in a position above the rail system such that content of the storage container is more accessible for a robotic/human picker located on the picker support.

In the picking position, the storage container handling device may be configured to support the storage container in a position above the rail system such that the remotely operated picking vehicle is able to move along the rail system without interference between the storage container and the rail system.

In the exchange position, the storage container handling device may be configured to support the storage container in a position that lets the grippers of the gripping device go clear the top of the storage container, such that the container handling vehicle can freely move away from the supported storage container.

The vehicle body has a footprint and the storage container support may extend outside the footprint.

The entire storage container support may be arranged outside the footprint of the vehicle body. This will typically be the case when the storage container support is a plate.

The storage container handling device may comprise a swivelling base. The swivelling base may be arranged on the vehicle body and configured to swivel a carried storage container 106 at least partly within the footprint of the vehicle body.

The remotely operated picking vehicle may have a footprint that covers an area with dimensions in the X and Y directions which is generally equal to the lateral extent of a storage column. The term ‘lateral’ used herein may mean ‘horizontal’.

Alternatively, the remotely operated picking vehicle may have a footprint which is larger than the lateral area defined by a storage column.

The remotely operated picking vehicle may have a rectangular vehicle body and comprise a plurality of storage container handling arranged on each side of the vehicle body. As an example, the remotely operated picking vehicle may have two storage container handling devices arranged on each side, which amount to a total of eight storage container handling devices.

A remotely operated picking vehicle with a rectangular vehicle body will typically have an area adjacent each corner of the vehicle body that are not obstructed by a storage container handling device. The remotely operated picking vehicle may access a storage container in the uppermost level of a storage column directly below these corner areas. If the storage container handling device is not supporting a storage container, further storage columns may be accessible below the area where the storage container would have been located.

The remotely operated picking vehicle may comprise a plurality of storage container handling devices, wherein each storage container handling devices may be configured to receive a storage container and to allow that storage container to be lowered into a respective access opening separately from the other containers.

The storage container handling devices can be moved independently of each other.

Each storage container handling device may be configured to support only one storage container.

The plurality of storage container handling devices may be arranged such that each storage container handling device simultaneously can be vertically aligned with a respective access opening in the rail system.

The automated storage and retrieval system may comprise a storage volume comprising storage columns arranged in rows between upright members, wherein storage containers are stacked one on top of another in the storage columns and access to the respective storage columns is provided by the access openings.

The present disclosure relates to an automated storage and retrieval system, wherein the system comprises:
a remotely operated picking vehicle as described herein;
a rail system comprising a first set of parallel rails arranged in a horizontal plane and extending in a first direction, and a second set of parallel rails arranged in the horizontal plane and extending in a second direction which is orthogonal to the first direction, wherein the first and second sets of rails form a grid pattern in the horizontal plane comprising a plurality of adjacent access openings defined by a pair of neighbouring rails of the first set of rails and a pair of neighbouring rails of the second set of rails;
a plurality of storage containers stored beneath a storage section of the rail system, wherein the storage containers are accessible through the access openings; and
a container handling vehicle comprising drive means for transportation on the rail system and a gripping device for lifting storage containers above the rail system.

The storage containers may be stored in stacks arranged in storage columns. Each storage column may be located vertically below an access opening.

The drive means may comprise a first set of wheels for moving the container handling vehicle along the rail system in the first direction X and a second set of wheels for moving the container handling vehicle along the rail system in the second direction Y.

The automated storage and retrieval system may comprise a control system configured to control the container handling vehicle, the remotely operated picking vehicle, and the robotic picker.

The automated storage and retrieval system may comprise a rail system with a double-double configuration, i.e. both the first set of rail extending in the X direction and the second set of rails extending in the second direction Y are all provided with double tracks. The double tracks allow two vehicles to cross each other while driving along the same rail.

The container handling vehicle is of cantilever construction. Such a vehicle is disclosed inter alia in NO317366.

The storage container handling device may be configured to lower the storage container to a position wherein an uppermost part of the storage container is at a lower or equal vertical elevation as the uppermost part of the rail system. The remotely operated picking vehicle may then receive and deliver a storage container to a cavity container handling vehicle, e.g. as disclosed in FIG. 4, WO2014/090684A1 or WO2019/206487A1.

The present disclosure relates to a method of handling products within storage containers stored in an automated storage and retrieval system as described herein, wherein the method comprises the steps of:
performing a storage container exchange between a remotely operated picking vehicle and a container handling vehicle,
carrying a storage container by means of a storage container handling device of a remotely operated picking vehicle, and
picking a product from the storage container carried by the remotely operated picking vehicle by means of a robotic picking device or a human picker arranged on the remotely operated picking vehicle.

The above steps do not need to be performed sequentially and each step may be repeated.

A storage container exchange may be performed prior to picking and involve delivering a storage container to a storage container handling device of the remotely operated picking vehicle by means of the container handling vehicle.

A storage container exchange may be performed after picking and involve retrieving a storage container from the storage container handling device by means of the container handling vehicle.

The method may comprise the following steps as part of the storage container exchange:
moving the remotely operated picking vehicle to a position where a storage container carried by the storage container handling device is in vertical alignment with one of the access openings in the rail system,
moving the storage container handling device to a position where it can support a storage container which is lowered at least partly into the access opening, and
delivering a storage container to the storage container handling device by means of the container handling vehicle, or
retrieving a storage container from the storage container handling device by means of the container handling vehicle.

When delivering a storage container to the storage container handling device, the container handling vehicle may perform at least some of the following steps:
carrying a storage container above the rail system,
moving to a position on the rail system where the carried storage container is vertically aligned with the storage container handling device,
lowering the storage container onto the storage container handling device by means of a lifting device,
releasing the storage container from the lifting device, typically by means of a gripping device of the lifting device,
raising the lifting device clear of the storage container,
moving along the rail system to retrieve a different storage container.

When retrieving a storage container from the storage container handling device, the container handling vehicle may perform at least some of the following steps:
moving to a position on the rail system where the lifting device is vertically aligned with the storage container handling device and the storage container carried by the storage container handling device,
lowering a lifting device of the container handling vehicle into engagement with the storage container,
connecting the lifting device to the storage container by means of a gripping device of the lifting device,
lifting the storage container off the storage container handling device by means of the lifting device,
lifting the storage container above the rail system by means of the lifting device,
moving along the rail system to store or deliver the storage container.

Before picking, the method may comprise the step of:
raising the storage container handling device to present the carried storage container to a robotic picking device or a human picker arranged on the picker support.

Before picking, the method may comprise the step of:
swivelling the storage container handling device to present the carried storage container to a robotic picking device or a human picker arranged on the picker support, such that the storage container 106 is at least partly within the footprint of the vehicle body 601.

The method may comprise the steps of:
moving the storage container handling device to a position where the carried storage container is above the rail system, and
moving the remotely operated picking vehicle along the rail system in a direction of a target storage container or a target port column.

The remotely operated picking vehicle may be moving during picking.

The remotely operated picking vehicle may comprise a plurality of storage container handling devices, and the method may comprise the steps of:
while exchanging a first storage container between a first container handling vehicle and a first storage container handling device, exchanging a second storage container between a second container handling vehicle and a second storage container handling device.

The present disclosure relates to a method of handling products within storage containers stored in an automated storage and retrieval system as disclosed herein, wherein each storage container comprises a flange, and a storage container handling device of a remotely operated picking vehicle comprises a pair of horizontally arranged arms configured to support the storage container by the flange, wherein the method comprises the steps of: retrieving a target storage container by means of a container handling vehicle; placing the target storage container in a storage column of the storage and retrieval system such that the target storage container extends above the rail system; moving the remotely operated picking vehicle to align the pair of horizontally arranged arms with the target storage container; raising the pair of horizontally arranged arms to lift the target storage container by the flange above the rail system; and picking a product from the target storage container carried by the remotely operated picking vehicle by means of a robotic picking device or a human picker arranged on the remotely operated picking vehicle. This method may be combined with any one of the above-mentioned steps.

After picking, the method may comprise the step of placing the storage container (no longer being a target storage container) in a storage column of the storage and retrieval system such that the target storage container extends above the rail system, by means of lowering the pair of horizontally arranged arms. The storage container may be returned to the storage column it was retrieved from. Alternatively, the remotely operated picking vehicle may move to another location on the rail system to place the storage container in a storage column different from the storage column it was retrieved from.

The container handling vehicle may retrieve a target storage container from beneath a storage section of the rail system. The container handling vehicle may also retrieve a target storage container through a port column.

The automated storage and retrieval system typically comprises a storage volume comprising storage columns arranged in rows between upright members, wherein storage containers are stacked one on top of another in the storage columns and access to the respective storage columns is provided by the access openings.

For a storage container to be placed in a storage column such that it extends above the rail system, a plurality of storage containers must be stored one on top of another in that storage column to form a stack of storage containers providing a base at the appropriate vertical elevation for the target storage container to be placed.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a storage container and product items stored in the storage container.

FIG. 6 is a perspective view of a remotely operated picking vehicle comprising a picker support and a plurality of storage container handling devices, wherein the remotely operated picking vehicle is operating in an automated storage and retrieval system and exchanging a storage container with a container handling vehicle.

FIG. 7 is a side view of the remotely operated picking vehicle of FIG. 6, wherein the container handling vehicle is carrying a storage container and approaching one of the storage container handling devices of the remotely operated picking vehicle.

FIG. 8 is a perspective view of a remotely operated picking vehicle similar to the one in FIG. 6 comprising a picker support and a plurality of storage container handling devices, wherein the remotely operated picking vehicle of FIG. 8 has a different storage container handling device configuration as compared to the remotely operated picking vehicle of FIG. 6.

FIG. 9 is a side view of the remotely operated picking vehicle of FIG. 8, wherein the remotely operated picking vehicle is movable along a rail system and is carrying a storage container that is partly lowered into an access opening in the rail system.

FIG. 10 is a side view of a detail from the remotely operated picking vehicle of FIG. 6, wherein some components are hidden for clarity, showing in particular the storage container handling device.

FIG. 11 is a side view of a detail from the remotely operated picking vehicle of FIG. 8, wherein some components are hidden for clarity, showing in particular the storage container handling device.

FIG. 12 is a perspective view of a remotely operated picking vehicle similar to the one in FIG. 8 comprising a picker support and a plurality of storage container handling devices, wherein the remotely operated picking vehicle of FIG. 12 has a different storage container handling device configuration as compared to the remotely operated picking vehicle of FIG. 8.

FIG. 13a is a perspective view of a container handling vehicle having placed a target storage container, to be picked from by a remotely operated picking vehicle, in layer Z=0 where it extends above the rail system.

FIG. 13b is a perspective view of a remotely operated picking vehicle, of the type illustrated in FIG. 8, approaching the target storage container placed in layer Z=0 by the container handling vehicle in FIG. 13a.

FIG. 13c is a perspective view of the remotely operated picking vehicle of FIG. 13b carrying the target storage container from which it can now pick products and bring along its further travel along the rail system or put back to the position where it was collected.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

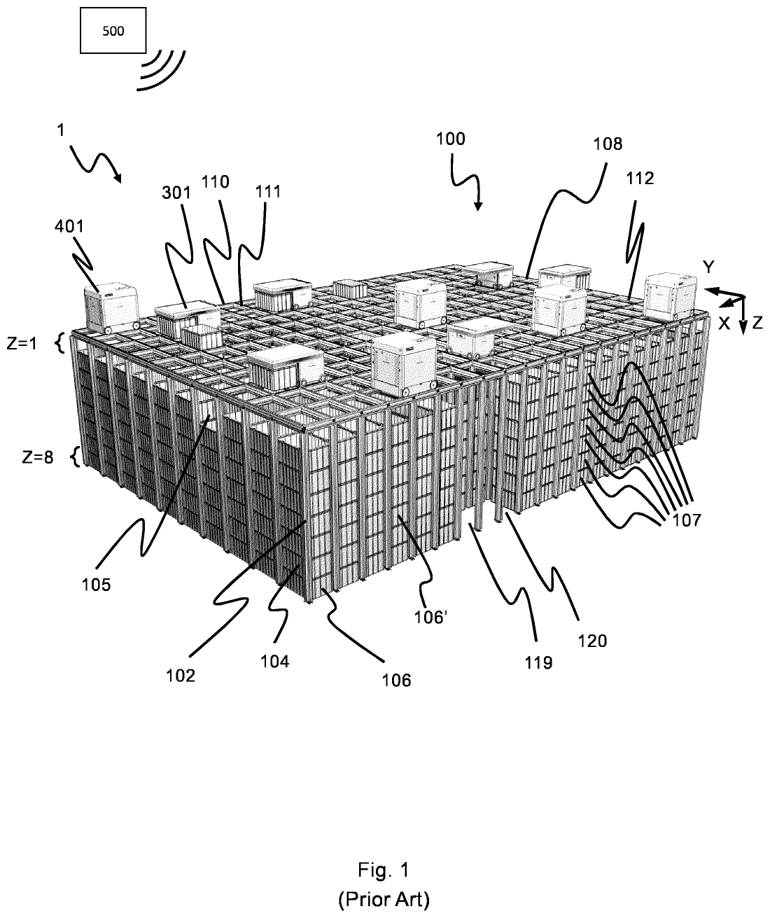

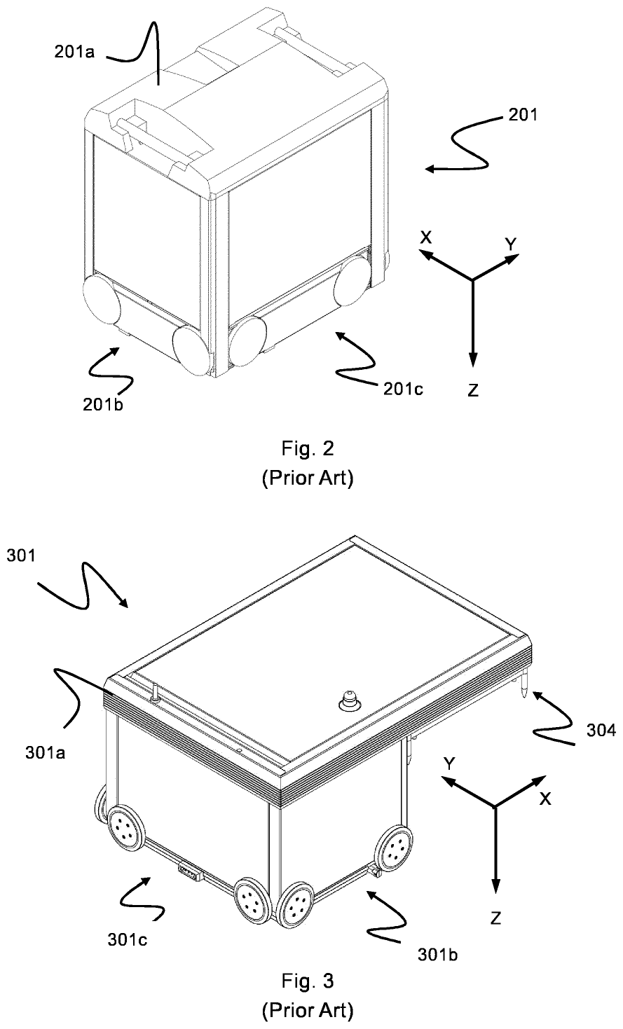

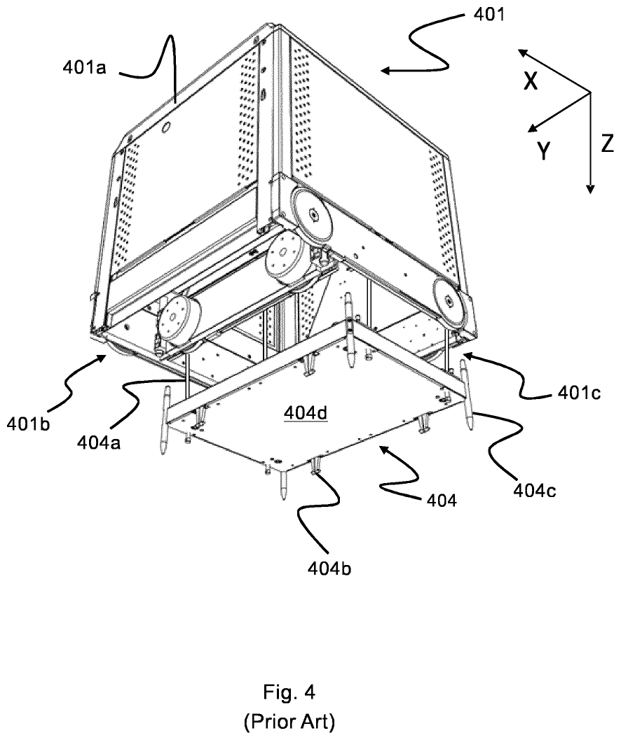

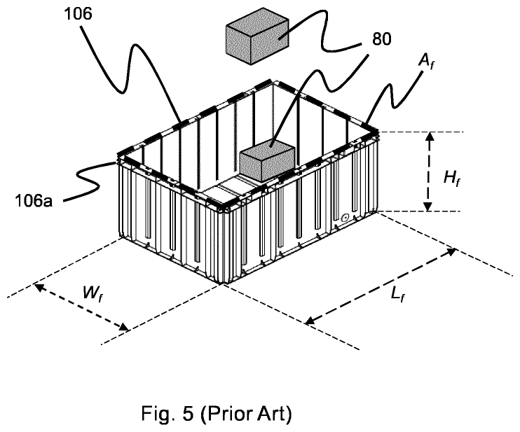

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the upright members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

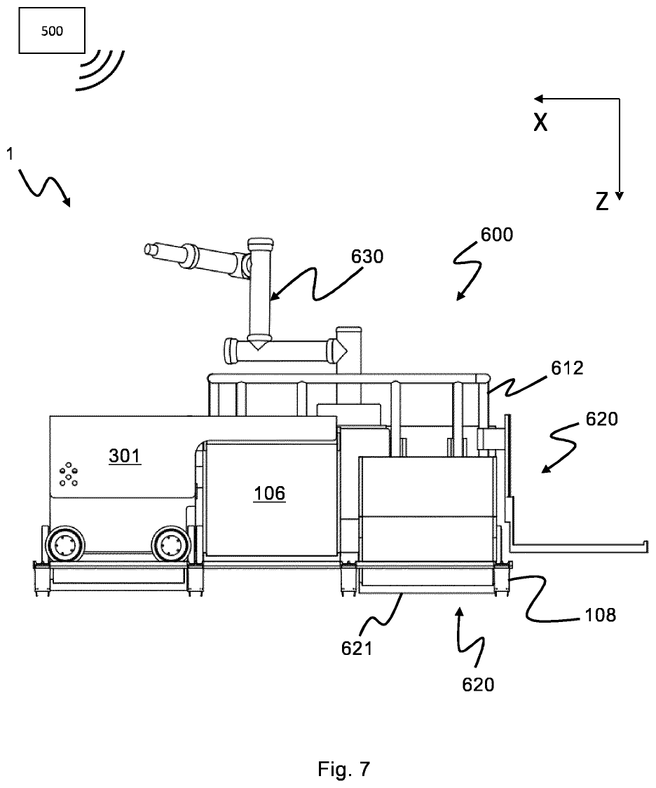

One embodiment of the remotely operated picking vehicle 600 will now be discussed in more detail with reference to FIGS. 6-11.

FIGS. 6-9 and 12-13c show a remotely operated picking vehicle 600 for retrieving and storing products within storage containers 106. The remotely operated picking vehicle 600 is configured to operate in an automated storage and retrieval system 1, e.g. the automated storage and retrieval system 1 as disclosed in FIG. 1. In FIGS. 6-9 and 12-13c, only some parts of the automated storage and retrieval system 1 is illustrated.

The automated storage and retrieval system 1 comprises a rail system 108 comprising a first set of parallel rails 110 arranged in a horizontal plane P_{H} and extending in a first direction X, and a second set of parallel rails 111 arranged in the horizontal plane P_{H} and extending in a second direction Y which is orthogonal to the first direction X. The first and second sets of rails 110,111 form a grid pattern in the horizontal plane P_{H} comprising a plurality of adjacent access openings 112 defined by a pair of neighbouring rails of the first set of rails 110 and a pair of neighbouring rails of the second set of rails 111.

The automated storage and retrieval system 1 may comprise a storage volume comprising storage columns 105 arranged in rows between upright members 102, wherein storage containers 106 are stacked one on top of another in the storage columns 105 and access to the respective storage columns 105 is provided by the access openings 112.

The exemplifying figures show only one remotely operated picking vehicle 600. However, two or more remotely operated picking vehicles 600 may operate in the same automated storage and retrieval system 1.

The automated storage and retrieval system 1 will typically comprise a plurality of storage containers 106 stored beneath a storage section of the rail system 108, wherein the storage containers 106 are accessible through the access openings 112 by means of container handling vehicles 201, 301, 401.

FIG. 6 shows only one container handling vehicle 301. However, as illustrated in FIG. 1, the automated storage and retrieval system 1 may comprise a plurality of container handling vehicles of one or more types. The container handling vehicles 210, 301, 401 comprise drive means for transportation on the rail system 108 and a gripping device 304 for lifting storage containers 106 above the rail system 108.

The container handling vehicle 301 may be a cantilever container handling vehicle. The container handling vehicle 201, 401 may also be a cavity container handling vehicle.

The remotely operated picking vehicle 600 illustrated in FIG. 6 comprises: a vehicle body 601 comprising drive means 602,603 for transportation on the rail system 108; a picker support 610 for a robotic picking device 630 or a human picker, the picker support 610 being arranged on the vehicle body 601; a plurality of storage container handling devices 620, arranged on the vehicle body 601.

The drive means may comprise: a first set of wheels 602, arranged on opposite sides of the vehicle body 601, for moving the remotely operated picking vehicle 600 along a first horizontal direction X on the rail system 108; and a second set of wheels 603, arranged on other opposite sides of the vehicle body 601, for moving the remotely operated picking vehicle 600 along a second horizontal direction Y on the rail system 108, the second direction Y being perpendicular to the first direction X.

In the example of FIG. 6, the remotely operated picking vehicle 600 comprises a robotic picking device 630 arranged on the picker support 610. Alternatively, a human picker may replace the robotic picker 630, or cooperate with the robotic picker 630.

FIGS. 6-9 show an example of a robotic picking device 630 arranged on the remotely operated picking vehicle 600. As illustrated, the robotic picking device 630 comprises a first robotic segment 631 connected to the vehicle body 601. The first robotic segment 631 may be a vertical column. The first robotic segment 631 is preferably rotatably connected to the vehicle body 601 with a first vertical rotational axis.

The robotic picking device 630 further comprises a gripper 635 configured to releasably grab a product 80 from within a storage container 106. The gripper 635 is at least indirectly connected to the first robotic segment 631. The gripper 635 is spaced at an adjustable radial gripper distance between the first robotic segment 631 and the gripper 635. The radial gripper distance is preferably sufficiently long for the gripper 635 to reach the storage containers 106 supported by the storage container handling devices 620.

As illustrated in FIGS. 6-9, the robotic picking device 630 may be a multi-joint robotic picking device. The robotic picking device 630 may then typically comprise a second robotic segment 632 connected to the first robotic segment 631. The second robotic segment 632 is preferably rotatably connected to the first robotic segment 631 with a first radial rotational axis perpendicular to the first vertical rotational axis, such that a longitudinal orientation of the second robotic segment 632 is adjustable relative to the first vertical rotational axis.

The robotic picking device 630 may further comprise a third robotic segment 633 connected to the second robotic segment 632. The third robotic segment 633 is preferably rotatably connected to the second robotic segment 632 with a third rotational axis. The third robotic segment could be connected to the gripper 635. In the illustrated example, the third robotic segment is indirectly connected to the gripper 635 via a fourth robotic segment 634.

The remotely operated picking vehicle 600 may comprise a camera system. The camera system typically comprises a camera 635 configured to visually inspect products 80 within storage containers 106 supported by storage container handling devices 620. Such a camera 635 may be directly or indirectly connected to one of the robotic segments 631, 632, 633, 634.

The camera system may further comprise a camera transmitter configured to transmit information from the visual inspection of the contents 80 to the control system 500, either directly or indirectly via the robotic picking device 630 or the remotely operated picking vehicle 600.

The number of robotic segments constituting the robotic arm and the direction of rotational axes may be varied according to the need of accuracy and/or flexibility and/or reach.

The robotic picking device 630 is typically in signal communication with a control system 500, either directly or indirectly via the remotely operated picking vehicle 600.

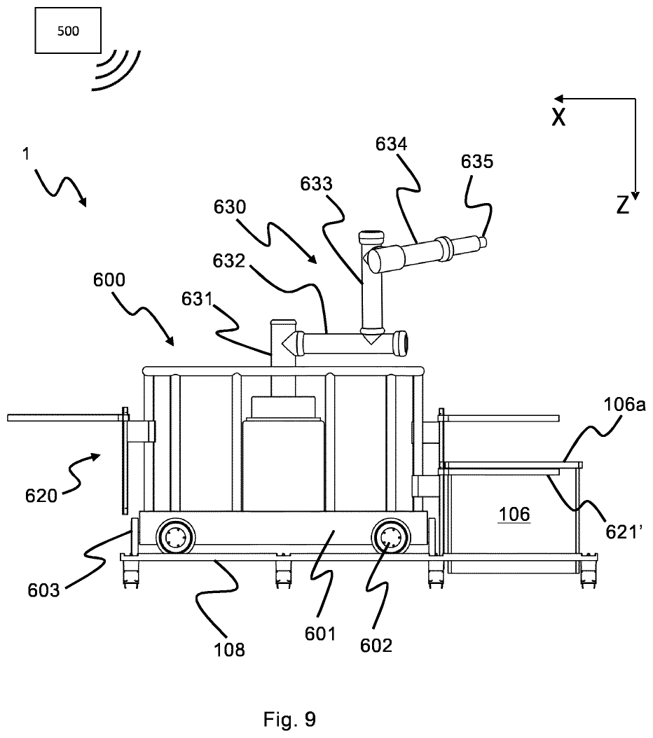

The robotic picking device 630 may have a radial gripper distance extending outside the footprint of the vehicle body 601. The gripper 635 may then be configured to releasably grab a product 80 from within a storage container 106 positioned below the rail system 108, preferably in an upper layer close to the rail system 108. A remotely operated picking vehicle 600 with a storage container handling device configuration as illustrated in FIG. 6 may be configured to reach storage containers 106 below the rail system 108 by the corners of the vehicle body 601. A remotely operated picking vehicle 600 with a storage container handling device configuration as illustrated in FIG. 8 may be configured to reach storage containers 106 below the rail system 108 by the corners of the vehicle body 601 or by the two sides of the vehicle body 601 where no storage container handling devices 620 are arranged. Alternatively, one or more storage container handling devices 620 may be configured to allow the picker to access an access opening 112 directly below the storage container handling device 620 when no storage container 106 is supported thereon.

The remotely operated picking vehicle 600 comprises at least one storage container handling device 620, preferably a plurality of storage container handling devices 620. In the example of FIG. 6 the remotely operated picking vehicle 600 comprises eight storage container handling devices 620. In the example of FIG. 8 the remotely operated picking vehicle 600 comprises four storage container handling devices 620. A higher number of storage container handling devices 620 may increase the picking capacity. With a higher number of storage container handling devices 620 the size of the remotely operated picking vehicle 600 will also increase.

Each storage container handling device 620 may have a horizontal extent, i.e. in the first direction X and the second direction Y, corresponding to an area of an access opening 112.

Each storage container handling device 620 may partly extend inside the footprint of the vehicle body 601. Each storage container handling device 620 may also partly extend outside the footprint of the vehicle body 601, e.g. an area corresponding to one access opening 112.

The storage container handling device 620 is configured to receive a storage container 106 from a container handling vehicle 301 operating on the rail system 108. The storage container handling device 620 is thus also configured for a container handling vehicle 301 to retrieve a storage container 106 therefrom.

If the remotely operated picking vehicle 600 comprises more than one storage container handling device 620, the remotely operated picking vehicle 600 may receive several storage containers 106 at the same time and thus cooperate with several container handling vehicles 301.

In the exemplifying figures, the storage container handling devices 620 are configured to support one storage container 106 each. However, the storage container handling devices 620 may be configured to support two or more storage containers 106 each, e.g. as exemplified in WO2022/112055A1.

The storage container handling device 620 is configured to support the storage container 106 when the storage container 106 is positioned such that it is at least partly lowered into one of the access openings 112 in the rail system 108. In that way the exchange of storage containers 106 between the remotely operated picking vehicle 600 and the container handling vehicles 310 can be facilitated.

The storage container handling device 620 is configured to move a supported storage container 106 vertically, i.e. up and down along the third direction Z.

The storage container handling device 620 may thus have an upper position and a lower position. A storage container 106 supported by the storage container handling device 620 will be above the rail system 108 when the storage container handling device 620 is in the upper position. And a storage container 106 supported by the storage container handling device 620 will be at least partly entered into one of the access openings 112 in the rail system 108 when the storage container handling device 620 is in the lower position. The storage container 106 may then be at least partly lowered into a storage column 105 below the access opening 112.

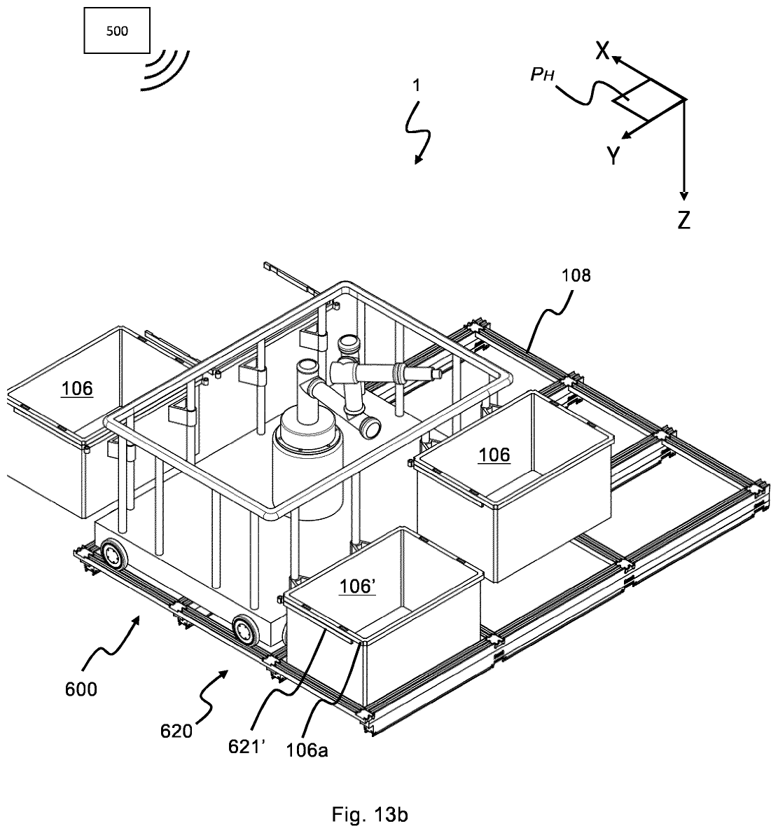

As illustrated in FIG. 12, the storage container handling device 620 may be configured to move a supported storage container 106 horizontally, i.e. along the first direction X and/or along the second direction Y. The storage container handling device 620 may comprise a swivelling base 625 and thus be configured to move the supported storage container 106 in a rotational manner, as in FIG. 12. Alternatively, the storage container handling device 620 may move the supported storage container 106 in a reciprocating manner. This can allow the supported storage containers 106 to be moved at least partly inside the footprint of the vehicle body 601. By picking from a storage container 106 that is at least partly inside the footprint of the vehicle body 601, issues relating to dropped items can be reduced. If the robotic or human picker drops a product 80 while picking, it is likely to land on the vehicle body 601 where it is easily retrieved instead of falling through the rail system 108 down to a position from where it will be cumbersome to retrieve it.

The storage container handling device 620 may comprise a storage container support 621;621′. The storage container support 621;621′ may be movable between an upper position and a lower position, wherein a storage container 106 supported by the storage container support 621;621′ is above the rail system 108 when the storage container support 621;621′ is in the upper position, and the storage container 106 supported by the storage container support 621;621′ is at least partly entered into one of the access openings 112 in the rail system 108 when the storage container support 621;621′ is in the lower position.

The storage container handling device 620 may comprise an elevator device 622 configured to raise and lower the storage container support 621;621′ relative to the vehicle body 601.

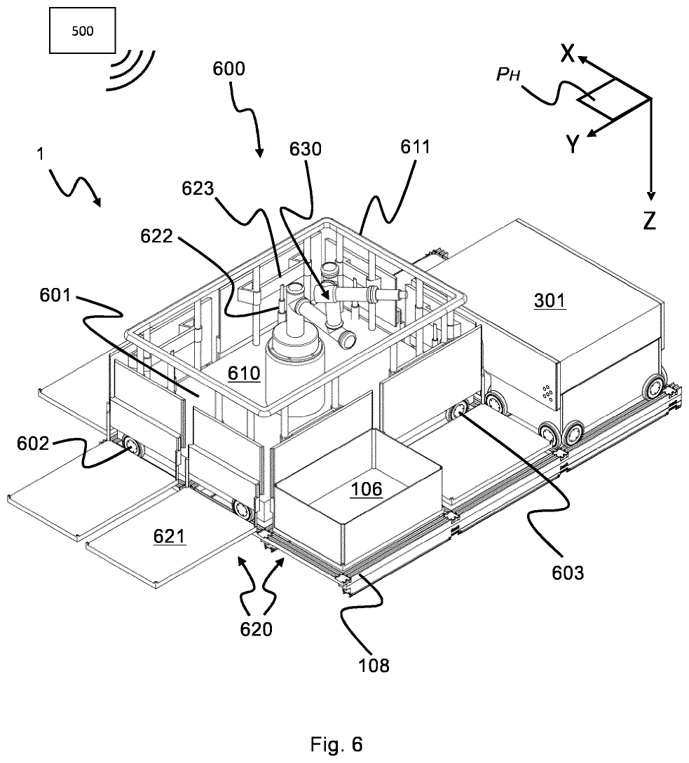

As illustrated in FIGS. 8, 9 and 11, the storage container support 621′ may comprise a pair of horizontally arranged arms. The horizontal arms may support a storage container 106 e.g. of the type disclosed in the prior art and FIG. 5.

As illustrated in FIG. 5, the prior art storage containers 106 typically comprise a flange 106a. The flange 106a may be arranged in an upper part of the storage container 106 close to its opening in the top. The flange 106a may extends outwards and around the storage container 106.

The horizontally arranged arms are configured to support the flange 106a on at least two opposing sides of the storage container 106 such that the storage container 106 can be hung off on the storage container support 621′.

The pair of horizontal arms may preferably extend away from the vehicle body 601.

The pair of horizontal arms may extend horizontally between 250-450 mm or between 350-650 mm, preferably at least 300 mm, more preferred at least 400 mm.

The storage container support 621′ may comprise a third arm arranged orthogonal to the pair of arms and parallel to the vehicle body 601.

The pair of horizontal arms may preferably be configured to support a weight of at least 30 kg.

The storage container support 621′ may comprise a fourth arm arranged orthogonal to the pair of arms and parallel to the third arm. The four arms may form a rectangular frame. In such case, the storage container 106 must be received and retrieved from above.

With the configuration with just the pair of arms or with just three arms, the storage container support 621′ may be configured for sideways receipt of the storage container 106.

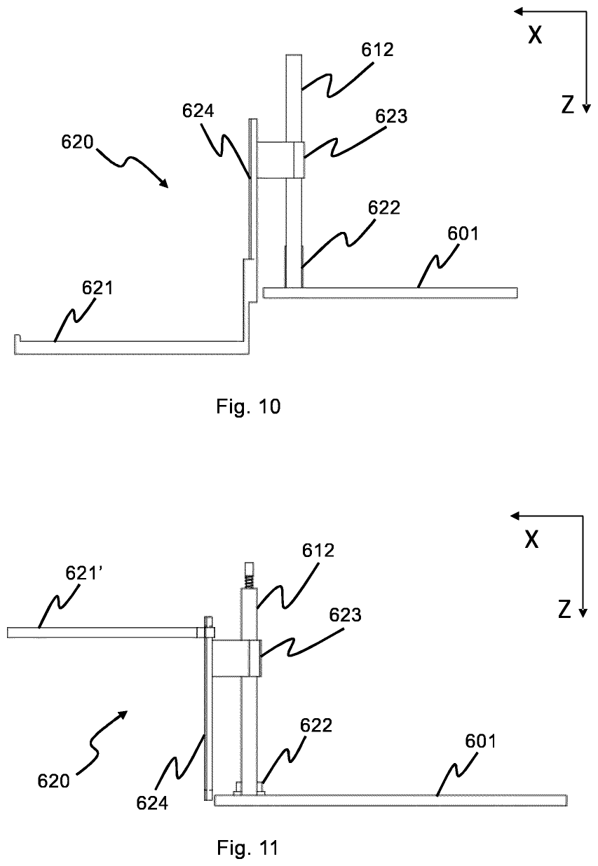

When the storage container support 621′ is configured for sideways receipt of the storage container 106, the storage container support 621′ may support the storage container 106 when the storage container 106 is positioned such that it is at least partly lowered into one of the access openings 112 in the rail system 108 without having to lower the storage container support 621′ into the access opening 112, which is the case in FIGS. 8 and 9. Furthermore, with this configuration of the storage container support 621′, the storage container handling device 620 may support the storage container 106 when the storage container 106 is positioned such that it is at least partly lowered into one of the access openings 112 in the rail system 108 without having to lower any one of its components into the access opening 112.

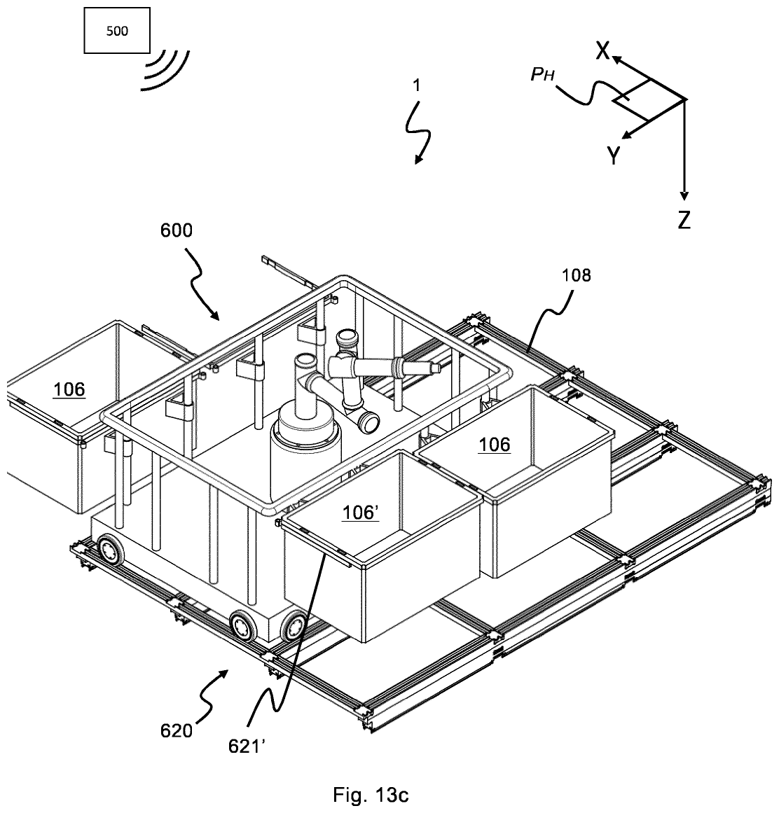

In addition to exchanging storage containers 106 with a container handling vehicle 301, this configuration of the storage container handling device 620 can also collect and put back storage containers 106 by itself if the storage containers 106 are extending above the rail system 108. An example of this is illustrated in FIGS. 13a-c and explained below.

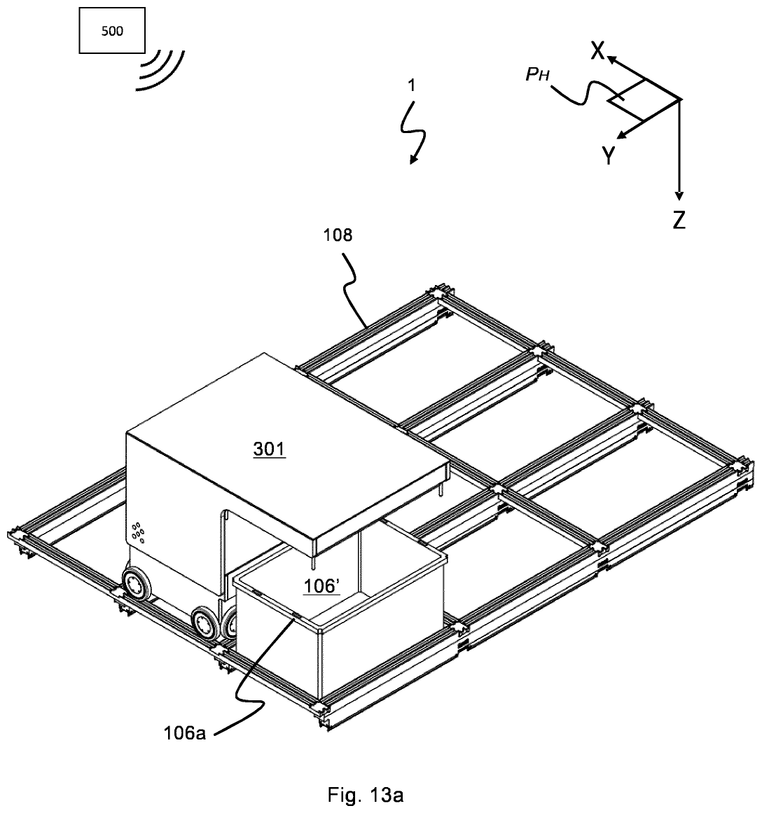

FIG. 11 shows a side view of details from FIGS. 8 and 9, wherein some components are hidden for clarity. The storage container handling device 620 is arranged on the vehicle body 601. In this example, the storage container handling device 620 is attached to the fence 611, in particular to two posts 612 of the fence 611. If the remotely operated picking vehicle 600 does not comprise a fence 611, or the fence 611 is not located close to the edge of the vehicle body 601, the storage container handling device 620 may comprise its own base, e.g. as illustrated in FIG. 12 wherein a swivelling base 625 is used. The base does not have to be swivelling, it may also be rotationally fixed. Other brackets for arranging the storage container handling device 620 on the vehicle body 601 can also be envisaged.

The example of FIG. 11 shows that the storage container handling device 620 may comprise one or more sleeve brackets 623 for connection to the posts 612. The sleeve bracket 623 is configured for vertical movement along the posts 612. If the storage container handling device 620 is connected to the fence 611 with one sleeve bracket 623, the sleeve bracket 623 may be configured for swivelling on the post 612, i.e. swivel relative the vehicle body 601. However, if the storage container handling device 620 is connected by means of two sleeve brackets 623, swivelling will typically be prevented. By swivelling the sleeve bracket 623 or moving it vertically, at least the storage container support 621′ will follow.

The storage container handling device 620 may comprise an elevator device 622 configured to move the storage container support 621′ up and down. In the example of FIG. 11, the elevator device 622 is arranged on the vehicle body 601 and configured to push or pull on the sleeve brackets 623 and in that way move the storage container support 621′ up and down. In this example, the elevator device 622 is a cylindrical actuator. If the storage container handling device 620 comprises two sleeve brackets 623, these sleeve brackets 623 may be connected by a horizontal beam, e.g. as seen in FIG. 6. One elevator device 622 can then move both sleeve brackets 623. Alternatively, one elevator device 622 can be provided for each sleeve bracket 623.

The sleeve bracket 623 may extend outside the footprint of the vehicle body 601, such that the storage container support 621′ is arranged outside the footprint of the vehicle body 601.

The storage container handling device 620 may comprise a side plate 624. The side plate 624 may improve structural integrity and also provide sideways support to a carried storage container 106. The storage container support 621′ may be connected to the sleeve bracket 623 directly or via the side plate 624. The side plate 624 may be configured to be lowered into the access openings 112.

The storage container support 621′ comprising horizontal arms, as seen in FIGS. 8, 9 and 11, will typically be above the rail system 108 also when lowering a storage container 106 into an access opening 112.

As illustrated in FIGS. 6, 7 and 10, the storage container support 621 may comprise a horizontal plate configured to receive a storage container 106 thereon. The horizontal plate may support a storage container 106 e.g. of the type disclosed in the prior art and FIG. 5.

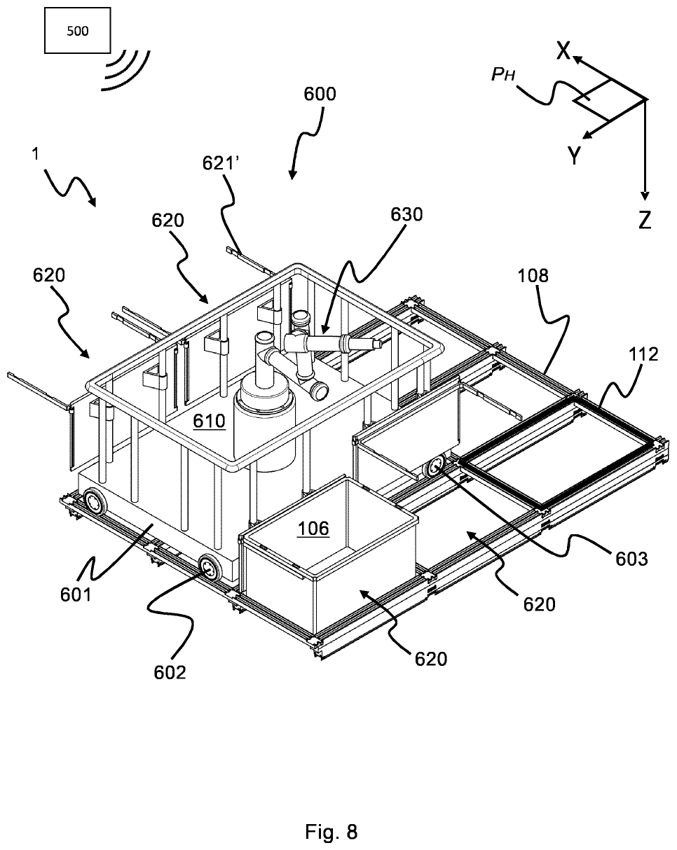

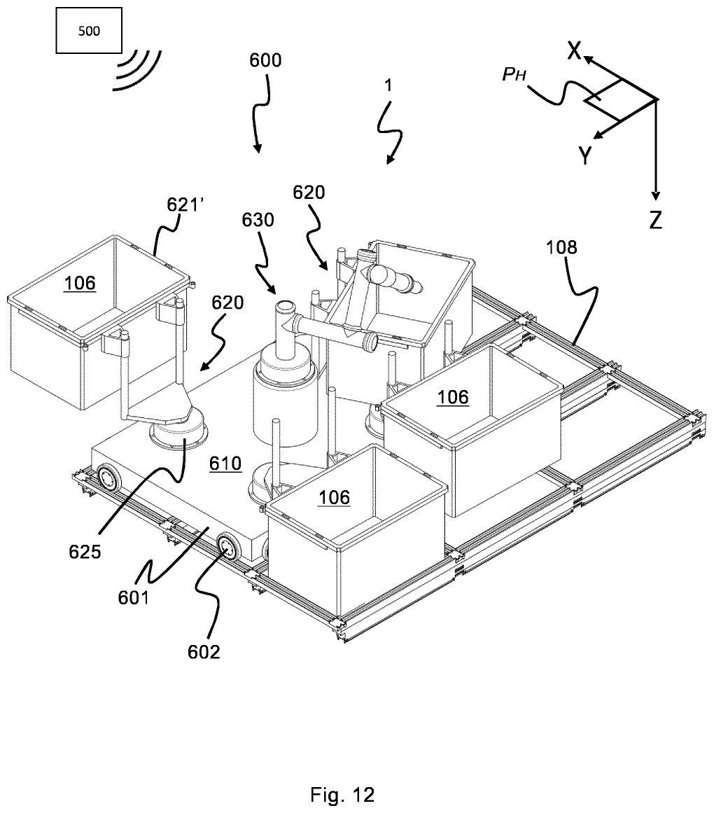

FIG. 10 shows a side view of details from FIGS. 6 and 7, wherein some components are hidden for clarity. The storage container handling device 620 may have a similar configuration as described for FIG. 11, except the different storage container support 621. The storage container support 621 comprising a horizontal plate will typically be lowered into the access opening 112 together with the carried storage container 106, as compared to the storage container support 621′comprising horizontal arms.

As suggested in FIGS. 6-9, 12, and 13b-c, the remotely operated picking vehicle 600 may comprise a plurality of storage container handling devices 620, wherein each storage container handling devices 620 is configured to receive a storage container 106 and to allow that storage container 106 to be lowered into a respective access opening 112 separately from the other containers 106. I.e. the storage container handling devices 620 may be configured to be operated individually and perform different tasks. As an example, two storage container handling devices 620 may carry one storage container 106 each, wherein one of the storage containers 106 is used for consolidation of costumer orders and the other storage container 106 is being picked from. At the same time, two storage container handling devices 620 may exchange storage containers 106 with respective container handling vehicles 301, wherein one storage container 106 is received and the other storage container 106 is retrieved.

One or more storage container handling devices 620 may carry one or more consolidation container(s). While picking products 80 from the storage containers 106, customer orders may be collected in the consolidation container. The consolidation container and the storage container may be identical.

One or more consolidation container(s) may be placed on the vehicle body 601, e.g. within the picker support 610.

To pick and complete a customer order, the remotely operated picking vehicle 600 will normally need to pick products 80 from several storage containers 106. To provide a flow of storage containers 106 in and out of the remotely operated picking vehicle 600, it will typically perform storage container exchanges with one or more container handling vehicle(s) 301.

To perform a storage container exchange, the remotely operated picking vehicle 600 moves to position one of its storage container handling devices 620 in vertical alignment with an access opening 112. In that way, a storage container 106 carried by the storage container handling device 620 can be lowered at least partly into the access opening 112.

When vertically aligned with an access opening 112, the storage container handling device 620 is lowered, regardless if it is carrying a storage container 106 or not. The storage container handling device 620 does not need to be lowered to its lower position as long as a storage container 106 carried, or to be carried, by the storage container handling device 620 will at least partly be lowered into the access opening 112. Such a situation wherein the container handling device 620 is carrying a storage container 106 is illustrated in FIGS. 8 and 9.

If the storage container handling device 620 is carrying a storage container 106, a container handling vehicle 301 not carrying a storage container 106 can then move to position its lifting device 304 in vertical alignment with the storage container 106 at least partly lowered into the access opening 112. The container handling vehicle 301 may then retrieve the storage container 106. To retrieve the storage container 106, the container handling vehicle 301 lowers its lifting device onto the storage container 106 and engages its grippers to the storage container 106. The container handling vehicle 301 can then lift the storage container 106 above the rail system 108 and move away from the remotely operated picking vehicle 600. FIG. 7 illustrates such a situation.

If the storage container handling device 620 is not carrying a storage container 106, a container handling vehicle 301 carrying a storage container 106 can then move to position the carried storage container 106 in vertical alignment with the storage container handling device 620. The container handling vehicle 301 may then deliver the storage container 106 to the remotely operated picking vehicle 600. To deliver the storage container 106, the container handling vehicle 301 lowers the storage container 106 onto the storage container handling device 620 by means of its lifting device. The grippers are then disengaged from the storage container 106 before the lifting device is retracted into the container handling vehicle 301. The storage container 106 is now carried by the remotely operated picking vehicle 600 and the container handling vehicle 301 can then move away from the remotely operated picking vehicle 600.

After a storage container exchange, the storage container handling device 620 must be raised above the rail system 108 before the remotely operated picking vehicle 600 can move along the rail system 108. Any other storage container handling devices 620 of the remotely operated picking vehicle 600 must also be raised above the rail system 108 before the remotely operated picking vehicle 600 can move along the rail system 108.

When the storage container handling device 620 is raised above the rail system 108 it will typically be closer to the robotic or human picker and its content thus more easily accessible for the picker. Moving the storage container handling device 620 to its upper position may therefore be beneficial when the picker is to pick from the storage container 106 carried by that storage container handling device 620.

The remotely operated picking vehicle 600 may pick a product 80 from the storage container 106 carried by the remotely operated picking vehicle 600 by means of a robotic picking device 630 or a human picker arranged on the remotely operated picking vehicle 600 both when the remotely operated picking vehicle 600 is moving and when it is standing still.

A storage container 106 may thus be received by the storage container handling device 620 while the remotely operated picking vehicle 600 is at a first position on the rail system 108 to then be retrieved from the storage container handling device 620 while the remotely operated picking vehicle 600 is at a second location on the rail system 108 at a later point in time.

The remotely operated picking vehicle 600 may move along the rail system 108 to shorten the traveling distance for the container handling vehicles 301 delivering and retrieving storage containers 106 to and from the remotely operated picking vehicle 600.

The remotely operated picking vehicle 600 will typically comprise a plurality of storage container handling devices 620, as seen in FIGS. 6-9 and 12-13c. The plurality of storage container handling devices 620 are preferably arranged to match the pattern of access openings 112 in the rail system 108 such that all storage container handling devices 620 can simultaneously be vertically aligned with respective access openings 112. So, by positioning one storage container handling device 620 in vertical alignment with an access opening 112, the other storage container handling devices 620 will align with other access openings 112.

If the remotely operated picking vehicle 600 comprises a plurality of storage container handling devices 620, these storage container handling devices 620 may preferably be operated independent of each other. E.g. a first storage container handling device 620 may be lowered while a second storage container handling device 620 is being raised while a third storage container handling device 620 is not moving while a fourth storage container handling device 620 is swivelling.

If the remotely operated picking vehicle 600 comprises a plurality of storage container handling devices 620, several storage container exchanges may take place at the same time. E.g. exchanging a first storage container 106 between a first container handling vehicle 301 and a first storage container handling device 620 while exchanging a second storage container 106 between a second container handling vehicle 301 and a second storage container handling device 620.

While the remotely operated picking vehicle 600 may typically perform bin exchange operations with container handling vehicles 301, storage containers 106 may be delivered and retrieved to and from the remotely operated picking vehicle 600 in other ways. One example is that the remotely operated picking vehicle 600 store and retrieve storage containers 106 by themselves, e.g. as illustrated in the sequence of FIGS. 13a-c.

In the sequence of FIGS. 13a-c, the remotely operated picking vehicle 600 retrieves a storage container 106 by itself. When the remotely operated picking vehicle 600 stores the storage container 106 again, the sequence is reversed.

In FIG. 13a, the remotely operated picking vehicle 301 has placed a target storage container 106′, i.e. a storage container 106 requested by the remotely operated picking vehicle 600, in a storage column 105 of the storage and retrieval system 1 such that the target storage container 106′ extends above the rail system 108. This storage level is referred to as Z=0 in the description of FIG. 1.

The storage container 106 illustrated in FIG. 13a-c is a prior art storage container 106 as also illustrated in FIG. 5. This storage container 106 comprises a flange 106a by which it can be lifted.

The remotely operated picking vehicle 600 illustrated in FIG. 13b-c, which retrieves the target storage container 106′ from FIG. 13a, has a storage container handling device 620 comprising storage container support 621′ comprising a pair of horizontally arranged arms configured to support the target storage container 106′ by the flange 106a.

In FIG. 13b, the remotely operated picking vehicle 600 has moved to align the pair of horizontally arranged arms with the target storage container 106′. To vertically align the pair of horizontally arranged arms with the target storage container 106′, the remotely operated picking vehicle 600 may first lower the storage container handling device 620 such that the pair of horizontally arranged arms have a lower vertical elevation than the flange 106a of the target storage container 106′. Then the remotely operated picking vehicle 600 may approach the target storage container 106′ from the side until the required alignment is achieved.

Once the pair of horizontally arranged arms are aligned with the target storage container 106′, the pair of horizontally arranged arms may be raised to lift the target storage container 106′ by the flange 106a above the rail system 108. Such a situation is illustrated in FIG. 13c. At that point picking may be performed from the target storage container 106′. The remotely operated picking vehicle 600 may move along the rail system 108 carrying the target storage container 106′ before returning it to storage, either where it was retrieved or at another location.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

LIST OF REFERENCE NUMBERS

| | |
|---|---|
| 1 | Prior art automated storage and retrieval system |
| 100 | Framework structure |
| 102 | Upright members of framework structure |
| 104 | Storage grid |
| 105 | Storage column |
| 106 | Storage container |
| 106a | Storage container flange |
| 106′ | Target storage container |
| 107 | Stack |
| 108 | Rail system |
| 110 | Parallel rails in first direction (X) |
| 112 | Access opening |
| 119 | First port column |
| 120 | Second port column |
| 201 | Prior art container handling vehicle |
| 201a | Vehicle body of the container handling vehicle 201 |
| 201b | Drive means/wheel arrangement/first set of wheels in first |
| | direction (X) |
| 201c | Drive means/wheel arrangement/second set of wheels in second |
| | direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 304 | Gripping device |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 500 | Control system |
| 600 | Remotely operated picking vehicle |
| 601 | Vehicle body of the remotely operated picking vehicle 600 |
| 602 | Drive means/first set of wheels in first direction (X) |
| 603 | Drive means/second set of wheels in second direction (Y) |
| 610 | Picker support |
| 611 | Fence |
| 612 | Post |
| 620 | Storage container handling device |
| 621 | Storage container support |
| 621′ | Storage container support |
| 622 | Elevator device |
| 623 | Sleeve bracket |
| 624 | Side plate |
| 625 | Swivelling base |
| 630 | Robotic picking device |
| 631 | First robotic segment |
| 632 | Second robotic segment |
| 633 | Third robotic segment |
| 634 | Fourth robotic segment |
| 635 | Gripper/camera |
| X | First direction |
| Y | Second direction |
| Z | Third direction |
| Af | Area of storage container |
| Hf | Height of storage container |
| Lf | Length of storage container |
| Wf | Width of storage container |

1-21. (canceled)

22. A remotely operated picking vehicle for an automated storage and retrieval system for retrieving and storing products within storage containers, wherein the automated storage and retrieval system comprises:
a rail system comprising a first set of parallel rails arranged in a horizontal plane and extending in a first direction, and a second set of parallel rails arranged in the horizontal plane and extending in a second direction which is orthogonal to the first direction, wherein the first and second sets of rails form a grid pattern in the horizontal plane comprising a plurality of adjacent access openings defined by a pair of neighbouring rails of the first set of rails and a pair of neighbouring rails of the second set of rails, wherein the remotely operated picking vehicle comprises:
a vehicle body comprising drive means for transportation on the rail system;
a picker support for a robotic picking device or a human picker, the picker support being arranged on the vehicle body;
a storage container handling device, arranged on the vehicle body, wherein the storage container handling device is configured to receive a storage container from a container handling vehicle operating on the rail system;
wherein the storage container handling device is configured to support the storage container when the storage container is positioned such that it is at least partly lowered into one of the access openings in the rail system to allow the storage container to be exchanged between the container handling vehicle and the storage container handling device.

23. The remotely operated picking vehicle according to claim 22, wherein the drive means comprises:
a first set of wheels, arranged on opposite sides of the vehicle body, for moving the remotely operated picking vehicle along a first horizontal direction on the rail system; and
a second set of wheels, arranged on other opposite sides of the vehicle body, for moving the remotely operated picking vehicle along a second horizontal direction on the rail system, the second direction being perpendicular to the first direction.

24. The remotely operated picking vehicle according to claim 22, wherein the storage container handling device comprises:
a storage container support.

25. The remotely operated picking vehicle according to claim 24, wherein the storage container handling device comprises:
an elevator device configured to raise and lower the storage container support relative to the vehicle body.

26. The remotely operated picking vehicle according to claim 24, wherein each storage container comprises a flange, and
wherein the storage container support comprises a pair of horizontally arranged arms configured to support the flange such that the storage container can be hung off on the storage container support.

27. The remotely operated picking vehicle according to claim 26, wherein the arms are configured for sideways receipt of the storage container.

28. The remotely operated picking vehicle according to claim 24, wherein the storage container support is a horizontal plate configured to receive a storage container thereon.

29. The remotely operated picking vehicle according to claim 22, wherein the storage container support is movable between an upper position and a lower position, wherein a storage container supported by the storage container support is above the rail system when the storage container support is in the upper position, and the storage container supported by the storage container support is at least partly entered into one of the access openings in the rail system when the storage container support is in the lower position.

30. The remotely operated picking vehicle according to claim 22, wherein the vehicle body has a footprint and the storage container support extends outside the footprint.

31. The remotely operated picking vehicle according to claim 22, wherein the remotely operated picking vehicle comprises:
a plurality of storage container handling devices,
wherein each storage container handling devices is configured to receive a storage container and to allow that storage container to be lowered into a respective access opening separately from the other containers.

32. The remotely operated picking vehicle according to claim 22, wherein the automated storage and retrieval system comprises:
a storage volume comprising storage columns arranged in rows between upright members, wherein storage containers are stacked one on top of another in the storage columns and access to the respective storage columns is provided by the access openings.

33. An automated storage and retrieval system, wherein the system comprises:
a remotely operated picking vehicle according to claim 22;
a rail system comprising a first set of parallel rails arranged in a horizontal plane and extending in a first direction, and a second set of parallel rails arranged in the horizontal plane and extending in a second direction which is orthogonal to the first direction, wherein the first and second sets of rails form a grid pattern in the horizontal plane comprising a plurality of adjacent access openings defined by a pair of neighbouring rails of the first set of rails and a pair of neighbouring rails of the second set of rails;
a plurality of storage containers stored beneath a storage section of the rail system, wherein the storage containers are accessible through the access openings; and
a container handling vehicle comprising drive means for transportation on the rail system and a gripping device for lifting storage containers above the rail system.

34. The automated storage and retrieval system according to claim 33, wherein the container handling vehicle is of cantilever construction.

35. A method of handling products within storage containers stored in an automated storage and retrieval system according to claim 33, wherein the method comprises the steps of:
performing a storage container exchange between a remotely operated picking vehicle and a container handling vehicle,
carrying a storage container by means of a storage container handling device of a remotely operated picking vehicle, and
picking a product from the storage container carried by the remotely operated picking vehicle by means of a robotic picking device or a human picker arranged on the remotely operated picking vehicle.

36. The method according to claim 35,
wherein a storage container exchange is performed prior to picking and involves delivering a storage container to a storage container handling device of the remotely operated picking vehicle by means of the container handling vehicle.

37. The method according to claim 35,
wherein a storage container exchange is performed after picking and involves retrieving a storage container from the storage container handling device by means of the container handling vehicle.

38. The method according to claim 35,
wherein the method comprises the following steps as part of the storage container exchange:
moving the remotely operated picking vehicle to a position where a storage container carried by the storage container handling device is in vertical alignment with one of the access openings in the rail system,
moving the storage container handling device to a position where it can support a storage container which is lowered at least partly into the access opening, and
delivering a storage container to the storage container handling device by means of the container handling vehicle, or
retrieving a storage container from the storage container handling device by means of the container handling vehicle.

39. The method according to claim 35,
wherein, before picking, the method comprises the step of:
raising the storage container handling device to present the carried storage container to a robotic picking device or a human picker arranged on the picker support, and optionally
wherein the method comprises the steps of:
moving the storage container handling device to a position where the carried storage container is above the rail system, and
moving the remotely operated picking vehicle along the rail system in a direction of a target storage container or a target port column.

40. The method according to claim 35,
wherein the remotely operated picking vehicle comprises a plurality of storage container handling devices, and
wherein the method comprises the step of:
while exchanging a first storage container between a first container handling vehicle and a first storage container handling device, exchanging a second storage container between a second container handling vehicle and a second storage container handling device.

41. A method of handling products within storage containers stored in an automated storage and retrieval system according to claim 33, wherein each storage container comprises a flange, and a storage container handling device of a remotely operated picking vehicle comprises a pair of horizontally arranged arms configured to support the storage container by the flange,
wherein the method comprises the steps of:
retrieving a target storage container by means of a container handling vehicle,
placing the target storage container in a storage column of the storage and retrieval system such that the target storage container extends above the rail system,
moving the remotely operated picking vehicle to align the pair of horizontally arranged arms with the target storage container,
raising the pair of horizontally arranged arms to lift the target storage container by the flange above the rail system, and
picking a product from the target storage container carried by the remotely operated picking vehicle by means of a robotic picking device or a human picker arranged on the remotely operated picking vehicle.
